(19) United States
(12) Patent Application Publication
(10) Pub. No.: US 2014/0121965 A1
(43) Pub. Date: May 1, 2014

(54) APPARATUS AND METHOD FOR SEARCHING MOVING ROUTE OF CARGO ON THE BASIS OF 3D INFORMATION

(71) Applicant: Electronics and Telecommunications Research Institute, Daejeon (KR)

(72) Inventors: Hong Kee KIM, Daejeon (KR); Dong Sik JO, Daejeon (KR); Jin Ho KIM, Daejeon (KR)

(21) Appl. No.: 13/919,118

(22) Filed: Jun. 17, 2013

(30) Foreign Application Priority Data
Oct. 30, 2012 (KR) 10-2012-0120926

(51) Int. Cl. G01C 21/00

(52) U.S. Cl. CPC G01C 21/00
USPC 701/527; 701/400

(57) ABSTRACT

Disclosed is a method for searching a moving route of a cargo on the basis of 3D information, including: acquiring workplace information including depth information by using a camera; generating 3D information on the workplace based on the acquired workplace information; and searching all the possible moving routes for each cargo to move from a start position to a target position on the basis of the generated 3D information to select moving routes for each cargo to move.

### CROSS-REFERENCE TO RELATED APPLICATIONS

This application claims priority to and the benefit of Korean Patent Application No. 10-2012-0120926 filed in the Korean Intellectual Property Office on Oct. 30, 2012, the entire contents of which are incorporated herein by reference.

### TECHNICAL FIELD

The present invention relates to an apparatus and a method for searching a moving route of a cargo, and more particularly, to an apparatus and a method for searching a moving route of a cargo using a 3D image.

### BACKGROUND ART

Requirements for transportation and handling of a container at a container berth have continuously increased and a process for a container handling technology and a loading and unloading technology has been required with newer and higher requirements. In recent, a necessity for a crane fixed to a berth and a crane mounted at a mobile harbor has increased, and therefore a necessity for a crane capable of more accurately and rapidly transferring a container has increased.

Even though the number of containers to be handled increases, a driver of a crane, such as a crane currently used for a harbor, an overhead traveler crane used for a factory, or the like, has performed an operation of moving cargos to a destination by visually estimating sizes and positions of the cargos through a window of the crane or with the help of an assistant at the ground on which the cargos are located, while sitting in a driver's seat at a high position.

As such, a driver performs a container handling operation by relying on his/her eyesight and experience, such that the driver has a difficulty in performing an operation along an optimized moving route of a cargo and the number of containers to be handled by the driver is limited due to the difficulty of operation.

### SUMMARY OF THE INVENTION

The present invention has been made in an effort to provide an apparatus and a method for searching an optimized moving route of a cargo without relying on an experience of a driver at the time of an operation of moving cargos using a crane.

The present invention has also been made in an effort to provide an apparatus and a method for searching a moving route of a cargo capable of suggesting an optimized route for moving a cargo to a target position to a driver prior to performing an operation of moving cargos so as to save operation time and cost.

An exemplary embodiment of the present invention provides a method for searching a moving route of a cargo on the basis of 3D information, including: acquiring workplace information including depth information by using a camera; generating 3D information on the workplace based on the acquired workplace information; and searching all the possible moving routes for each cargo to move from a start position to a target position on the basis of the generated 3D information to select moving routes for each cargo to move.

In the generating of the 3D information, the generated 3D information may include start positions and target positions for each cargo to move, a size of the workplace, and positions and heights of obstacles present in the moving routes.

The selecting of the moving routes may include: virtually moving each cargo to move from the start position to the target position; arranging the virtual moving route when the cargo to move reaches the target position to extract a length of the arranged route and the moving route; and sequentially repeating the virtually moving of each cargo and the arranging of the virtual moving route as much as a preset number of times, and then determining the shortest moving route for each cargo to move.

In the virtually moving of each cargo, a sum of moving probabilities of the cargo to move may be set to 1 in four directions and the moving possibilities may increase in a direction approaching the target position and decrease in a direction far away from the target position.

In the virtually moving of each cargo, when obstacles are present in a moving direction of the cargo to move, the moving probability of the cargo to move may be 0.

In the virtually moving of each cargo, the moving directions of the cargo to move in a previous step and a current step may approach the target position and when the moving directions of the cargo to move are the same, the moving probability may increase.

In the virtually moving of each cargo, when the moving directions of the cargo to move in a previous step and a current step are opposite to each other, the moving probability may decrease.

Another exemplary embodiment of the present invention provides an apparatus for searching a moving route of a cargo on the basis of 3D information, including: an image acquisition unit that acquires workplace information including depth information; a 3D information generation unit that generates 3D information on the workplace based on the acquired workplace information; and a route setting unit that searches all the possible moving routes for each cargo to move from a start position to a target position on the basis of the generated 3D information to select moving routes for each cargo to move.

The 3D information generation unit may generate the 3D information including start positions and target positions for each cargo to move, a size of the workplace, and positions and heights of obstacles present in the moving routes.

The route setting unit may include: a virtual moving unit that virtually moves each cargo to move from the start position to the target position; a route arrangement unit that arranges the virtual moving route when the cargo to move reaches the target position and extracts a length of the arranged route and the moving route; and a route determination unit that sequentially repeats the virtually moving of each cargo and the arranging of the virtual moving route as much as a preset number of times and then determines the shortest moving route for each cargo to move.

The virtual moving unit may set a sum of moving probabilities of the cargo to move to 1 in four directions and increase the moving probability in a direction approaching the target position and decrease the moving probability in a direction far away from the target position.

The virtual moving unit may set the moving probability of the cargo to move to 0 when obstacles are present in a moving direction of the cargo to move.

The virtual moving unit may make the moving directions of the cargo to move in a previous step and a current step approach the target position and when the moving directions of the cargo to move are the same, increase the moving probability.

The virtual moving unit may decrease the moving probability when the moving directions of the cargo to move in a previous step and a current step are opposite to each other.

The apparatus and method for searching a moving route of a cargo according to the exemplary embodiments of the present invention can suggest the optimized moving route and the moving order of cargos to the driver after figuring out the on-the-spot conditions prior to performing the operation of moving cargos without relying on the experience of the driver, thereby saving the operation time and cost.

The apparatus and method for searching a moving route of a cargo according to the exemplary embodiments of the present invention can suggest the optimized moving route and the moving order of cargos to the user even when intending to move complex and various cargos to several places, thereby reducing the possibility of accidents due to the operation of the crane.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an apparatus for searching a moving route of a cargo on the basis of 3D information according to an exemplary embodiment of the present invention.

FIG. 2 is a flow chart of a method for searching a moving route of a cargo on the basis of 3D information according to an exemplary embodiment of the present invention.

FIG. 3 is a detailed flow chart of a process of suggesting moving routes for each cargo of FIG. 2.

FIG. 4 is a plan view illustrating a simplified workplace for describing in detail a virtual moving process of FIG. 3.

FIG. 5 is a diagram illustrating an arranged moving route when a cargo virtually moves to a target position.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. It is to be noted that in giving reference numerals to components of each of the accompanying drawing, like reference numerals refer to like elements even though the like components are shown in different drawings. In describing exemplary embodiments of the present invention, well-known functions or constructions will not be described in detail since they may unnecessarily obscure the understanding of the present invention and terms described in a singular form may include a plural concept. In addition, exemplary embodiments of the present invention will be described below but the technical idea of the present invention is not limited or restricted, and may be modified and variously carried out by a person having ordinary skill in the art to which the present invention pertains.

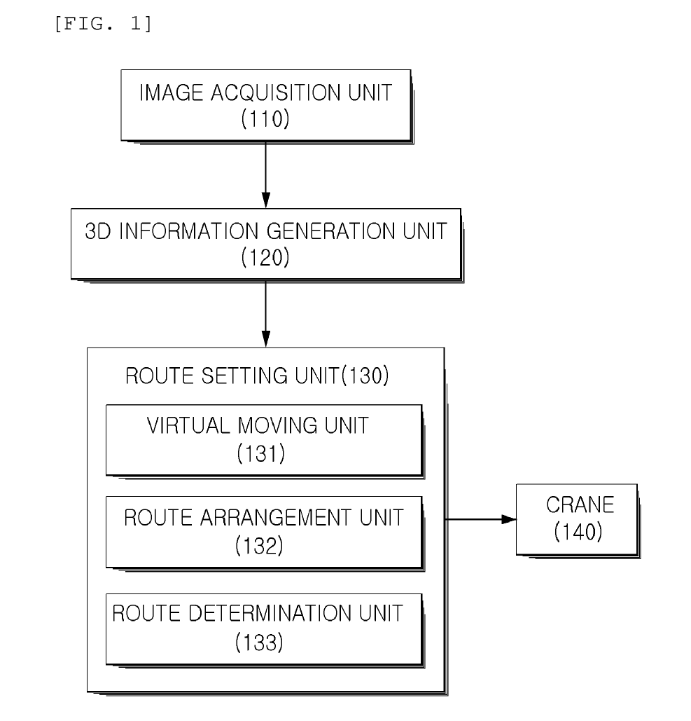

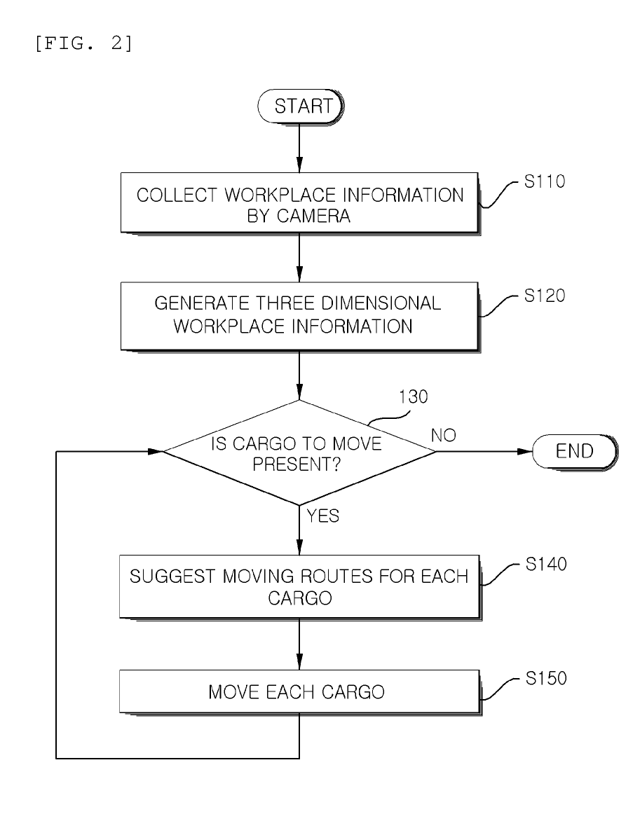

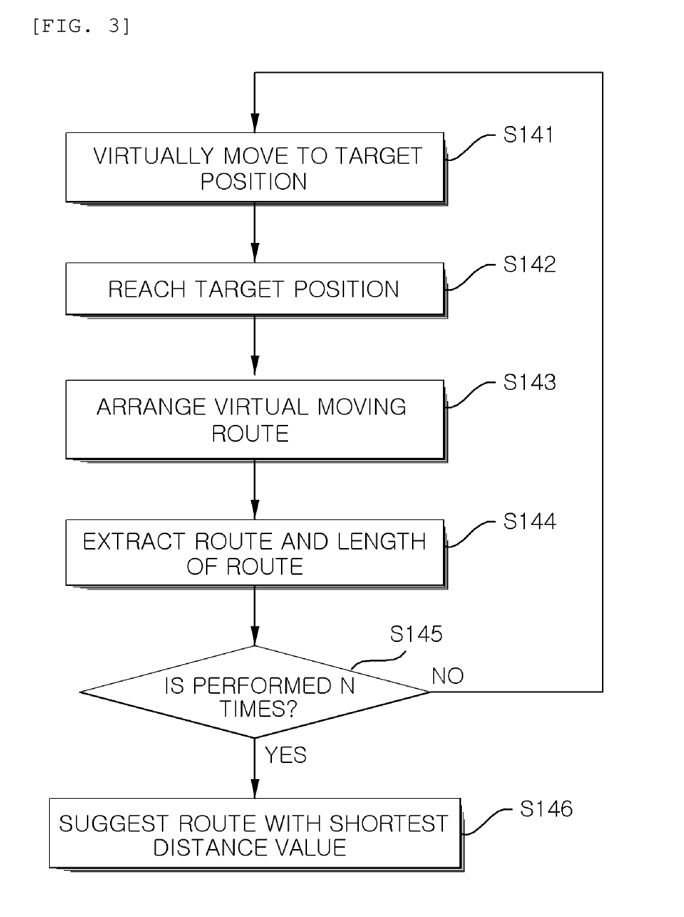

FIG. 1 is a block diagram illustrating an apparatus for searching a moving route of a cargo on the basis of 3D information according to an exemplary embodiment of the present invention, FIG. 2 is a flow chart of a method for searching a moving route of a cargo on the basis of 3D information according to an exemplary embodiment of the present invention, and FIG. 3 is a detailed flow chart of a process of suggesting moving routes for each cargo of FIG. 2.

Referring to FIGS. 1 to 3, the apparatus for searching a moving route of a cargo on the basis of 3D information according to the exemplary embodiment of the present invention includes an image acquisition unit 110, a 3D information generation unit 120, and a route setting unit 130. In this configuration, the route setting unit 130 includes in detail a virtual moving unit 131, a route arrangement unit 132, and a route determination unit 133.

In detail, the image acquisition unit 110 acquires workplace information including depth information (S110) and the 3D information generation unit 120 generates 3D information on workplace on the basis of the acquired workplace information (S120). The route setting unit 130 determines whether cargos to move are present (S130) and if it is determined that the cargos to move are present, searches all the possible moving routes for each cargo to move from a start position to a target position on the basis of the generated 3D information to select the moving routes for each cargo to move (S140). The selected route is suggested to a user, such that the user moves a cargo 10 to move to a target position using a crane (S150).

Describing in detail the route setting unit 130, the virtual moving unit 131 virtually moves each cargo to move from the start position to the target position, the route arrangement unit 132 arranges the virtual moving route when the cargo to move reaches the target position to extract a length of the arranged route and the moving route, and the route determination unit 133 sequentially repeats the virtually moving of each cargo and the arranging of the virtual moving route as much as a preset number of times and then determines the shortest moving route for each cargo to move (S140).

Hereinafter, the apparatus and method for searching a moving route of a cargo on the basis of 3D information according to the exemplary embodiment of the present invention will be described in more detail.

According to the exemplary embodiment of the present invention, as the image acquisition unit 110, a depth camera may be used but various image collection units capable of representing depth information of a film site may be used.

First, the overall appearance of a workplace in which an operation of moving cargos using a crane 140 is performed is photographed by the depth camera 110 (S110). The size of the workplace and the position and the target position of the cargo are figured out and sizes and positions of obstacles in the route are figured out, through the photographing. The photographed information is used for the 3D information generation unit 120 to generate the 3D information on the workplace (S120). When the generation of the 3D information on the workplace is completed, the information on the size including the size/area of the workplace, the current position and the target position of the cargo, and the positions and heights of the obstacles may be figured out. The information thereon is used for the route setting unit 130 to figure out the route along which the cargo moves (S140).

When the information on the workplace is figured out, it is determined whether a cargo to move is present (S130) and if it is determined that the cargo to move is present, the virtual moving unit 131 virtually moves each cargo from a start position to a target position to figure out routes for each cargo (S141 and S142). When cargos reach a target position, the route arrangement unit 132 arranges the virtual moving route and figures out the length of the arranged route and the moving route to suggest the shortest route among the figured out candidate routes (S143 and 144). The route determination unit 133 sequentially repeats the virtually moving of each cargo (S141 and S142) and the arranging of the virtual moving route (S143 and S144) as much as a preset number of times and then determines the shortest moving route for each cargo to suggest the shortest distance route to a user, and the like (S146).

The method for searching a moving route of a cargo on the basis of 3D information according to the exemplary embodiment of the present invention is operated in such a manner that the user, and the like, uses the crane 140 to end the operation through a process (S150) of actually moving cargos along the route suggested through the processes.

Other matters to be considered in performing the method for searching a moving route of a cargo on the basis of 3D information according to the exemplary embodiment of the present invention are as follows.

If there is a moving order of cargos to move, the cargos moves from a start position to a target position according to the defined order and if there is no defined moving order, cargos consistently move from left to right or from right to left.

1. At the time of suggesting the routes for each cargo, the shortest route is suggested to reduce costs due to the movement.

2. There is a need to figure out the size including the positions and heights of obstacles.

3. The target position at which each cargo is located needs to be figured out.

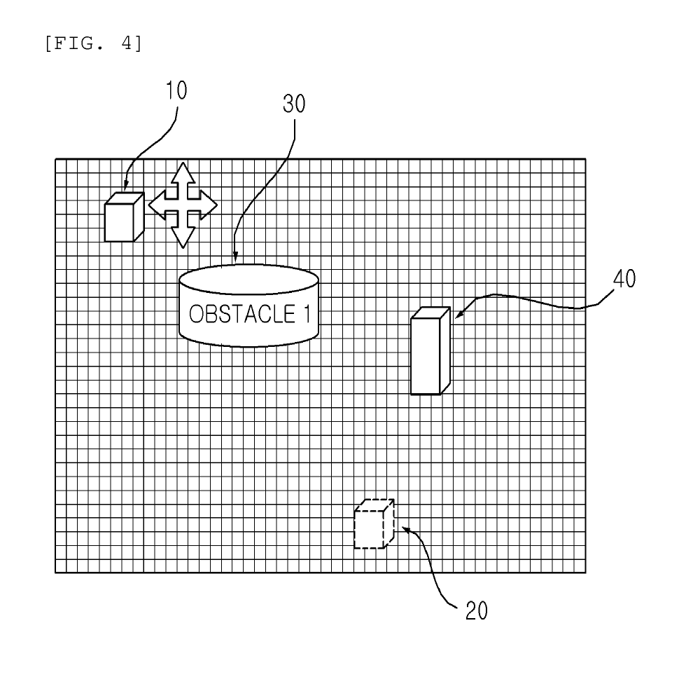

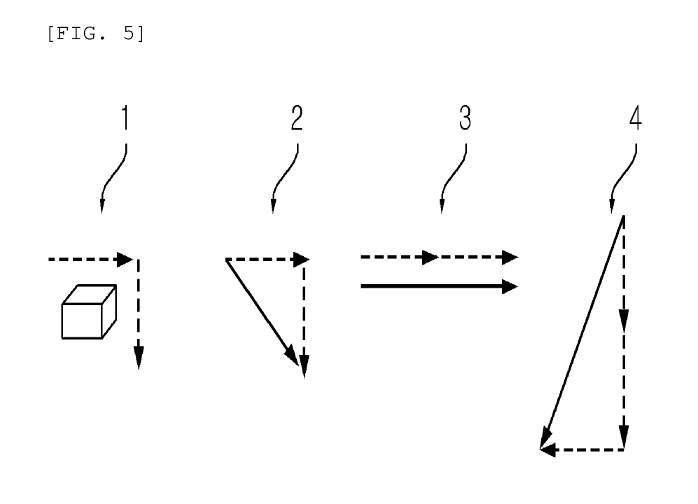

FIG. 4 is a plan view illustrating a simplified workplace for describing in detail a virtual moving process of FIG. 3 and FIG. 5 is a diagram illustrating an arranged moving route when a cargo virtually moves to a target position.

Hereinafter, the process of suggesting the route for each cargo (S140) will be described in detail with reference to FIGS. 4 and 5.

The virtual movement of one cargo from a start position to a target position starts (S141). The rules for the movement will be described with reference to FIGS. 3 and 4. When the moving cargo reaches the target position (S142), the virtual moving route until now is arranged (S143) and the length of the arranged route and the route are extracted (S144). The operation is repeatedly performed up to a preset number of times N that a user desires. After the operation is repeatedly performed, the shortest distance route among N times of routes is searched and thus the route is suggested (S146).

FIG. 4 is a plan view illustrating a simplified workplace for describing in detail a virtual moving process of FIG. 3. The cargo 10 to move is present at left upper. The final target position is present at right lower 20 from a center. The cargo 10 needs to move from a current start position to a target position but obstacles 30 and 40 are present on the way of the route. In order to move cargos from a start position under the situations, a unit distance movement in four directions of up and down and left and right directions like a crisscross pattern is performed. In this case, the determination on whether to move cargos in any of the four directions depends on the following policies.

1. A moving probability for the four directions is allocated.

2. A sum of four-direction moving probability is 1.

3. A high probability is allocated to a direction approaching the target position on the basis of the information on the current position and the target position.

4. A low moving probability is allocated to a direction far away from the target position.

5. If obstacles (position, size, and height are figured out in advance) are present in the moving direction, the moving probability is 0.

6. If the movement of the previous step is movement approaching the target position and the current direction is the same direction as the previous direction and is a direction toward the target position, a high probability is allocated.

7. For the opposite direction to the previous direction, a low probability is allocated as a penalty.

The route is stored while virtually moving each cargo from a start position to a target position according to the moving probability policy. When the cargo reaches the target position, the arrangement operation for the moving route is performed as illustrated in FIG. 5.

In FIG. 5, if there is a portion at which the directions are synthesized at the time of arranging the moving routes, a policy of performing the synthesis is illustrated. The policy serves to move cargos only in four directions because virtually simulating the movement in all directions of 360° has degraded efficiency.

Describing the diagram of FIG. 5 from left to right, a first diagram (1) is an appearance in which a cargo horizontally moves to the right and then vertically moves downwardly, which shows the case in which the synthesis may not be made due to the presence of obstacles between the two movements. A second diagram (2) shows the same movement as the first diagram (1), but the synthesis can be made due to the absence of obstacles, such that the route is arranged in a diagonal line. A third diagram (3) shows the case in which the consecutive movement in the same direction is arranged and a fourth diagram (4) shows the case in which the consecutive movement downwardly two times and the movement to the left once is synthesized and arranged. Arranging the routes as described above, the routes are arranged as a diagonal route, such that the routes may be reduced. The length and information of the routes arranged by the foregoing performance are stored.

As described above, the route for one cargo from a start position to a target position is figured out and the same operation is performed as much as the desired number of times N. By doing so, a probability of searching the optimized route of the shortest distance, deviating from the obstacles becomes high. After the repetitive performance as much as N times, the shortest route among the routes is selected and is suggested as the route of cargo (S146). Next, the user may use the crane 140 to directly move cargos or the cargos may automatically move, along the suggested route. Further, the remaining cargos that do not move yet are moved depending on the overall operation method.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for searching a moving route of a cargo on the basis of 3D information, comprising:
acquiring workplace information including depth information by using a camera;
generating 3D information on the workplace based on the acquired workplace information; and
searching all the possible moving routes for each cargo to move from a start position to a target position on the basis of the generated 3D information to select moving routes for each cargo to move.

2. The method of claim 1, wherein in the generating of the 3D information, the generated 3D information includes start positions and target positions for each cargo to move, a size of the workplace, and positions and heights of obstacles present in the moving routes.

3. The method of claim 1, wherein the selecting of the moving routes includes:
virtually moving each cargo to move from the start position to the target position;
arranging the virtual moving route when the cargo to move reaches the target position to extract a length of the arranged route and the moving route; and
sequentially repeating the virtually moving of each cargo and the arranging of the virtual moving route as much as a preset number of times, and then determining the shortest moving route for each cargo to move.

4. The method of claim 3, wherein in the virtually moving of each cargo, a sum of moving probabilities of the cargo to move is set to 1 in four directions and the moving probabilities increase in a direction approaching the target position and decreases in a direction far away from the target position.

5. The method of claim 4, wherein in the virtually moving of each cargo, when obstacles are present in a moving direction of the cargo to move, the moving probability of the cargo to move is 0.

6. The method of claim 4, wherein in the virtually moving of each cargo, the moving directions of the cargo to move in a previous step and a current step approach the target position and when the moving directions of the cargo to move are the same, the moving probability increases.

7. The method of claim 4, wherein in the virtually moving of each cargo, when the moving directions of the cargo to move in a previous step and a current step are opposite to each other, the moving probability decreases.

8. An apparatus for searching a moving route of a cargo on the basis of 3D information, comprising:
an image acquisition unit that acquires workplace information including depth information;
a 3D information generation unit that generates 3D information on the workplace based on the acquired workplace information; and
a route setting unit that searches all the possible moving routes for each cargo to move from a start position to a target position on the basis of the generated 3D information to select moving routes for each cargo to move.

9. The apparatus of claim 7, wherein the 3D information generation unit generates the 3D information including start positions and target positions for each cargo to move, a size of the workplace, and positions and heights of obstacles present in the moving routes.

10. The apparatus of claim 7, wherein the route setting unit includes:
a virtual moving unit that virtually moves each cargo to move from the start position to the target position;
a route arrangement unit that arranges the virtual moving route when the cargo to move reaches the target position to extract a length of the arranged route and the moving route; and
a route determination unit that sequentially repeats the virtually moving of each cargo and the arranging of the virtual moving route as much as a preset number of times and then determines the shortest moving route for each cargo to move.

11. The apparatus of claim 10, wherein the virtual moving unit sets a sum of moving probabilities of the cargo to move to 1 in four directions and increases the moving probability in a direction approaching the target position and decreases the moving probability in a direction far away from the target position.

12. The apparatus of claim 11, wherein the virtual moving unit sets the moving probability of the cargo to move to 0 when obstacles are present in a moving direction of the cargo to move.

13. The apparatus of claim 11, wherein the virtual moving unit makes the moving directions of the cargo to move in a previous step and a current step approach the target position and when the moving directions of the cargo to move are the same, increases the moving probability.

14. The apparatus of claim 11, wherein the virtual moving unit decreases the moving probability when the moving directions of the cargo to move in a previous step and a current step are opposite to each other.
